(19) United States
(12) Patent Application Publication
(10) Pub. No.: US 2022/0121900 A1
(43) Pub. Date: Apr. 21, 2022

(54) METHODS AND SYSTEMS FOR GENERATING UNCLONABLE OPTICAL TAGS

(71) Applicant: Arizona Board of Regents on Behalf of Northern Arizona University, Flagstaff, AZ (US)

(72) Inventors: Abolfazl Razi, Flagstaff, AZ (US); Zaoyi Chi, Flagstaff, AZ (US)

(21) Appl. No.: 17/505,547

(22) Filed: Oct. 19, 2021

Related U.S. Application Data
(60) Provisional application No. 63/093,688, filed on Oct. 19, 2020.
(60) Provisional application No. 63/257,508, filed on Oct. 19, 2021.

(51) Int. Cl. G06N 3/00; G06V 10/75; G06V 10/50; G06V 10/46; G06T 5/00

(52) U.S. Cl. CPC G06N 3/002; G06V 10/76; G06V 10/50; G06T 5/009; G06V 10/758; G06T 5/002; G06V 10/467

(57) ABSTRACT

Systems and methods for authenticating dendritic product tags are disclosed. An authentication authority fabricates and digitally images a dendrite. A shape of the dendrite is numerically modeled as a graph including nodes. The nodes correspond to seed, bifurcation and termination points of the dendrite. Each node is associated in a database with a two value vector corresponding to the length and orientation of a linear approximation of the branch terminating at the node. This model is compared to a model built by a remote application of a dendritic tag encountered in the field, and product information including an indication of authenticity is sent if the models match. Matching occurs by an ad-hoc comparison between nodes in the models, which comparison involves comparing child, parent and sibling nodes.

### CROSS REFERENCE TO RELATED APPLICATIONS

This application claims priority to U.S. Provisional Patent Application No. 63/093,688 filed on Oct. 19, 2020, and U.S. Provisional Patent Application No. 63/257,508 filed on Oct. 19, 2021, the disclosures of which are incorporated herein in their entirety.

### FIELD OF THE INVENTION

Inventive embodiments are directed to unclonable, optical product identification and authentication labels in general, and in particular, optical product identification and authentication labels including dendrite structures.

### BACKGROUND

Assuring the authenticity of products in commerce is a matter of existing and growing importance. The modern supply chain is long, complex and increasingly globalized. This increases the opportunity to insert low quality, grey market and outright counterfeit merchandize into the stream of commerce. Indeed, today's supply chains and markets are witnessing growing threats from the insertion of low-quality fake parts on a daily basis. The financial impacts of counterfeiting and brand identity fraud exceed $1 trillion worldwide. The consequences are not limited to economic impacts. People's health can be jeopardized by black market foods and medicine. The Centers for Disease Control and Prevention (CDC) estimates that about 10% to 30% of pharmaceutical drugs sold in developing countries are counterfeit. Thus, non-genuine products introduced into the $75B pharmaceutical market poses not only significant economic risk, but the World Health Organization has called the situation a global health to human safety. Additionally, fake and deliberately mislabeled automotive parts can compromise driving safety and put the lives of drivers and vehicle passengers at risk. Critical military hardware may fail due to bogus parts used by the defense system. Even homeland security can be compromised if fake electronics devices penetrate the production line of information systems.

Conventionally, unique visual indicia of authenticity are used for product authentication. Such visual identifiers, such as Barcodes and QR codes, are the most popular forms used for such identifiers. Barcodes and QR codes are conventionally printed onto product tags adhered to products. These tags encode text-based information (e.g., product ID, fabrication date, manufacturer, and the country of origin) into 1-D and 2-D patterns with universal mapping. The tags may be scanned, for example, with a mobile device camera, to decode the encoded information. According to a recent survey conducted by Statistia, in the US alone, an estimated 11 million households will scan a QR code in 2020. Unfortunately, QR codes and 1-D bar codes can be easily reproduced. Thus, despite their low price and easy scanning, these copiable visual tags do not provide any security.

Holograms address this concern because they are difficult to copy. Thus, holograms are used in sensitive products like ID cards and luxury products to protect them against counterfeiting by leveraging 3D appearance of light diffraction. Replicating the diffraction effects of holograms is difficult and complex, which disincentivizes attempts to copy. However, holograms have certain drawbacks in that they have a very distinctive appearance, which may not be suitable for some products. They also are less capable of conveying digital information for identification purpose.

Increasingly, electronic tags such as RFID tags are used for product authentication, particularly for sensitive or expensive products. When activated by an electromagnetic signal of a specific predetermined frequency emitted by an RFID reader, an RFID tag emits a specific electromagnetic response signal, which can be received and decoded by the reader. RFID is likely the most commonly used method of electronic identification of objects, and it is used in a number of applications including toll collection (EZ Pass), Logistics, Asset Tracking, etc. RFID, however, has certain weaknesses. The readers are relatively expensive, and the tags themselves can be analyzed and their response can be cloned or spoofed. Additionally, the relatively high cost of RFID systems restricts their use to only high-value items, or at pallet or crate level for cheaper products.

Other conventional product authentication technologies suffer from similar disadvantages. For example, there exist more advanced identification solutions based on complicated circuitry such as microelectronics-based smart cards and contactless Near-Field Communication (NFC) cards, which are used in banking systems, electronic payment systems, and wireless networks, etc. However, such solutions are more complicated and too costly for the widespread labeling of low-price daily goods. Furthermore, electronics devices are vulnerable to electronic attacks such as side-channel attacks, Focused Ion Beam (FIB) edits, micro-probing, and Chemical Mechanical Polishing (CMP) tear down after removing the passivation layer on the chip. These solutions require electronics-based personalization before use as another burden.

Even more recently, the use of intrinsic fabrication variability of electronic devices for developing Physical Unclonable Functions (PUFs) has gained a lot of attention from the research community. Electronic PUFs are widely used as a reliable means of identification and authentication since they exploit the natural randomness and the fabrication variability of electronic components to produce unique and unclonable device identifiers. Examples of electronic PUFs include ring oscillators, programmable delay lines, arbiters, and memory arrays. A key advantage of the use of electronic PUFs for identification is that little or no additional cost is incurred at the device level as they use existing device elements.

Although very successful in eliminating counterfeiting threats, the use of such devices is conventionally limited to more sensitive applications and advanced electronic products like the Internet of Things (IoT) nodes and military equipment. The reason for the limited deployment of conventional PUF based authentication systems is there cost—conventional PUFs are generally realized in semiconductor integrated circuits such as semiconductor memories. Such PUFs are too expensive for widespread deployment on low cost consumer goods. Additionally, electronic PUFs cannot be considered fully secure. For instance, cloning attacks on Static Random-Access Memories (SRAMs) have become possible using focused ion beam circuit edit. In addition to the vulnerability of electronic PUFs to side-channel attacks, there exist two limiting factors. Firstly, a complicated custom-built circuitry is often required for the identification purpose that can make the reader costly, as opposed to the optical PUFs that can be interrogated using simple cameras. Secondly, electronic PUFs are usable only for specific microelectronic devices, hence they cannot be considered as a universal and low-cost solution for other applications.

In a different line of research, biometric identification methods are developed for human identification using facial images, fingerprints, iris, DNA-taggants, outer ear shape, and gait analysis from video frames. These methods, again, are obviously not suitable for trust marking of low cost generic products. Other methods like laser engraving, microtext, and fluorescent overlay are applicable only to specific products like ID cards. Considering the shortcomings and practical issues of using electronic PUFs, the use of advanced optical tags with machine intelligence is gaining traction in academic research and industry projects for future markets.

Current solutions for labeling, tracing, and authenticating products in international supply chains need substantial improvements.

### SUMMARY

Counterfeiting (injecting fake and inauthentic parts), identify theft (extracting the product-specific information from the easily readable tags), and cloning attacks (replacing original parts with fake ones) constitute threats to the supply chains. To mitigate these security threats, this disclosure provides a server-client security solution based on the authenticating dendritic tags.

Inventive embodiments are directed to security solutions based on optical security against counterfeiting attacks. Systems according to certain embodiment use metal dendrites as nano-scaled, unclonable identifiers, a web-based parallelizable graph-theoretic authentication algorithm, and a reader technology with network connectivity and adapters for high-resolution imaging.

A dendrite is a common growth form in nature, which appears, for example, in the shapes of biological structures like neurons and coral, mineral deposition patterns, patterns of metal crystallization, and other crystal growth patterns, such as ice crystals. The crystallization of dendrites forms a fractal pattern, which is to say, a pseudorandom pattern that roughly repeats as an observer zooms in on smaller sub-parts. This quality is called self-similarity. The characteristic shape of a dendrite is treelike, having a series of straight trunk portions leading to in y-shaped branching portions (i.e., trunk bifurcations).

The growth of metal dendrites (e.g., silver dendrites) in an electrolytic ion source by electrolysis has been described. U.S. Pat. No. 10,074,000 describes methods for silver dendrite growth usable in conjunction with the embodiments described herein, and that reference is incorporated herein in its entirety.

Inventive embodiments exploit the uniqueness of metal dendrite shapes by using such shapes to generate physically unclonable optical labels. According to certain embodiments, metallic dendrites are grown over non-reactive substrates, and are then coated with durable coating layers. Because of natural fabrication variabilities, the metallic growth pattern is unique, and the resulting label may be used for authentication and product tracking. In one aspect, the dendrites are grown in an electrochemical process using ionizing silver molecules. The resulting silver structure exhibits repeated self-similar bifurcation patterns, i.e., radial dendritic structures. These structures exhibit extreme granularity, nano-scaled 3D facets, and have specific illumination properties making them an optimal choice for product tagging.

In certain embodiments, metal dendrites are grown on durable substrates (e.g., paper) by electrolysis. The substrates may be laminated and coated with an adhesive to form adhesive labels. The dendrite patterns on the substrate-bearing labels are graphically characterized during an enrollment process using a machine vision system. According to a graphical characterization process, a mathematical graphical model of the dendrite is generated by an image capture and analysis process, and the model is stored in a secure database, optionally with additional pieces of information relating to the labeled product. The label may then be adhered to a product placed into the stream of commerce. Parties in possession of the label can image the dendrite label, the image data may be mathematically characterized to model the dendrite, and the resulting model may be compared to the stored model to authenticate the label and retrieve the previously stored. For reasons that will be discussed, the label imaging process may be performed by relatively low resolution, low magnification optics, such as those found in a typical mobile phone. The self-same nature of metal dendrites permits an authentication authority to initially characterize a dendrite with high resolution imagery, under high magnification, and then to compare the stored, derived model to lower magnification imagery (or models derived therefrom) taken with lower quality machine vision systems (e.g., mobile phone cameras).

In some aspects, the dendrites are characterized using a graph-theoretic algorithm that utilizes regular cameras for commercial applications. The extreme granularity and nano-scaled resolution of dendrites provide enough capacity to tag every molecule on earth with unique numbers if need be, so the scalability never becomes an issue for this technology.

One embodiment is directed to a method of modeling a metal dendrite, as may be used on a product tag. The method includes forming an image of the dendrite, digitizing the image, and processing the digital image in processed digital image data. The method also includes analyzing the processed digital image data to identify features of the dendrite, and on the basis of the analysis, generating a numerical representation of the dendrite in the form of a graph.

In one aspect, analyzing the digital image to identify features of the dendrite includes identifying the dendrite's seed point, points of bifurcation and points of branch termination. In one aspect, generating a numerical representation of the dendrite in the form of a graph comprises: representing at least a portion of the dendrite as a series of nodes, each node representing one of the identified seed point, a point of bifurcation or a point of branch termination. Each node may be associated with a two-element vector representing the length and orientation of a branch terminating to the node. One or more nodes may also be associated with a branching level of the dendrite.

In one aspect, processing the digitized image resulting in a processed digital image comprises performing one or more of the following image processing functions: conversion to YCbCr color space, segmentation, binarization, smoothing and thinning.

Another embodiment is directed to a method of assessing similarity between a first numerical representation of a dendrite shape and a second numerical representation of a dendrite shape. Each numerical representation includes a series of nodes associated with a two-element vector representing a length and orientation of a branch terminating to the node. The method includes selecting a first node in the first numerical representation, selecting a first node in the second numerical representation. The method also includes determining that the selected first node in the first numerical representation matches the selected a first node in the second numerical representation on the basis of a comparison of the two-element vectors of each node.

In one aspect, the values of the two element vectors associated with nodes of the first numerical representation and the second numerical representation are normalized, for example, on the basis of the mean and standard deviation of the values of the two element vectors of the nodes associated with each respective numerical representation.

In certain aspects, the method includes computing a consistency score associated with a match between the first node in the first numerical representation and the first node in the second numerical representation. The consistency score is based on a comparison of the two-element vectors of child, sibling or parent nodes for each of the first node of the first numerical representation and the first node of the second numerical representation. If the consistency score exceeds a predetermined consistency threshold, the two nodes are matched, and a fresh pair of unmatched nodes is selected, and the process repeats. If the consistency score does not exceed the predetermined consistency threshold, the nodes are not matched, and may be reused with other matching candidate nodes.

In one embodiment, a method of authenticating an article of commerce is provided. The method includes fabricating a tag including a dendrite, generating a digital image of the dendrite, and generating a first mathematical model of at least a portion of the shape of the dendrite as a collection of nodes representing one of the dendrite's seed, bifurcation or termination points. Each node may be associated with a two-element vector representing a length and orientation of a branch terminating to the node. The method further includes storing the first mathematical model of at least a portion of shape of the dendrite in a database. The method also includes receiving a second mathematical model of at least a portion of the shape of a dendrite. The second mathematical model may be generated remotely, e.g., by someone downstream in commerce in possession of a product tag. The second mathematical model represents at least a portion of the shape of the dendrite as a collection of nodes representing one of the dendrite's seed, bifurcation or termination points, where each node is associated with a two-element vector representing a length and orientation of a branch terminating to the node. The first and second mathematical models are compared, and on the basis of the comparison, the method determines whether the second mathematical model was derived from the same dendrite as the first mathematical model.

In one aspect, the first and second mathematical models are compared by selecting a first node in the first mathematical model, selecting a first node in the second mathematical model, and determining that the selected first node in the first model matches the selected a first node in the second mathematical model on the basis of a comparison of the two-element vectors of each node. The method may also include computing a consistency score associated with a match between the first node in the first mathematical model and the first node in the second mathematical model based on a comparison of the two-element vectors of child, sibling or parent nodes for each of the first node of the first numerical representation and the first node of the second numerical representation.

Inventive embodiments have certain advantages over conventional product authentication systems. Inventive systems offer a low-cost and secure mechanism to protect supply chains and logistic systems against counterfeiting and identity theft by labeling products with unique identifiers that are easy to investigate but technically impossible to clone with existing technology. Additionally, authentication may be performed with inexpensive, existing technology such as cameras already present on mobile devices.

In particular, new security solutions based on inventive optical identifiers are nano-scaled and exhibit almost infinite entropy, and as such, are appropriate for large scale networks. End-to-end security solutions using inventive systems are able to offer: (i) low-cost label fabrication technology for mitigating counterfeit and cloning attacks, (ii) bio-safe and environment-friendly security tags, (iii) low-complexity authentication software with user-friendly interface and portable adapters for high-resolution imaging, (iv) wireless Internet connectivity and cloud-based computation, and (v) graph-based compression for reduced storage and communication overhead. Security systems according to inventive embodiments require little investment in the supporting infrastructure, which enables inventive security systems and methods to be deployed and adopted globally.

In addition to allowing for products themselves to be optically authenticated, the mathematical dendrite model at the core of certain embodiments may be used for cryptographic key generation. Specifically, product-specific numerical data derived from the dendrite label graphical model can be used as security keys for more advanced cryptographic methods. For instance, the numerical information can be translated into the 128-bit cryptographic keys of Advanced Encryption Standard (AES) and Triple Data Encryption (3DES) ciphering algorithms. It can also be used as private key in Public Key Infrastructure (PKI) infrastructures that use RSA or Elliptic Curve Cryptography (ECC) methods. This technology is also integrable with the emerging blockchain technology. Likewise, numerical information of dendrites can be used to create PKI-based digital signatures for transactions in distributed ledgers.

As will become apparent in considering the following disclosure, optical PUFs of the sort described herein have significant commercial advantages over RFID tags and electronic PUFs. While RFID tags are low cost, they can be cloned. And while more complex electronic PUFs are more resistant to cloning, they are expensive, and critically, can require complex hardware to both enroll and to read for authentication. Therefore, electronic PUFs cannot replace image-based solutions, at least when considering widespread use, because optical PUFs may be read using inexpensive, widely available equipment like mobile phone cameras. The optical PUFs disclosed herein use the concept of extracting unique, random, and high-entropy features from images for identification purposes, and they achieve all of these advantages using inexpensive hardware.

The above features and advantages of the present invention will be better understood from the following detailed description taken in conjunction with the accompanying drawings.

### BRIEF DESCRIPTION OF THE DRAWINGS

The drawings described herein constitute part of this specification and includes exemplary embodiments of the present invention which may be embodied in various forms. It is to be understood that in some instances, various aspects of the invention may be shown exaggerated or enlarged to facilitate an understanding of the invention. Therefore, drawings may not be to scale.

FIG. 1 depicts one sample dendrite wafer panel including 24×24=576 dendrites (a) compared in size to a quarter coin in (b); (c) is a sample dendritic pattern grown on inkjet paper.

FIG. 2 illustrates the extreme granularity (nano-scaled) and self-similar Y-shaped elements in a dendrite pattern.

FIG. 3 depicts an overall architecture of a security system according to an inventive embodiment, including local readers, an access network, and back end web-based authentication servers.

FIG. 4A depicts a process flow for deploying and using dendritic security labels according to an inventive embodiment.

FIG. 4B schematically depicts an alternative process flow and arrangement for deploying and user dendritic security labels.

FIG. 5 depicts a process for fabricating dendritic security labels according to an inventive embodiment.

FIG. 6 depicts an exemplary method for graphically characterizing a dendrite, and for measuring the dendrite in the field for comparison with the originally characterized image.

FIG. 7 depicts an exemplary process for comparing reference models of a dendrite with measurements to eliminate false mapping.

FIG. 8 depicts an exemplary achieved matching rate for a number of modeled dendrites.

### DETAILED DESCRIPTION OF THE PREFERRED EMBODIMENTS

The present embodiments will now be discussed in detail with regard to the attached drawing figures that were briefly described above. In the following description, numerous specific details are set forth illustrating the Applicant's best mode for practicing the invention and enabling one of ordinary skill in the art to make and use the invention. It will be obvious, however, to one skilled in the art that the present invention may be practiced without many of these specific details. In other instances, well-known machines, structures, and method steps have not been described in particular detail in order to avoid unnecessarily obscuring the present invention. Unless otherwise indicated, like parts and method steps are referred to with like reference numerals.

### Dendrite Tagging Technology

A dendrite (from the Greek word dendron, meaning “tree”) is a structure that develops with a continuously branching tree-like form. Such patterns are common in nature, appearing in plants, animals, and natural features. Electrochemical dendrites present intricate branching patterns that possess a singular and unique set of minutiae for every instance of formation so that no two of them are likely to be the same, even in large populations, much like fingerprints of people. The pattern variations arise from the mechanisms involved in the electrochemical self-assembly process so that individuality and non-reproducibility are natural outcomes, thereby simplifying the manufacture of these identifiers.

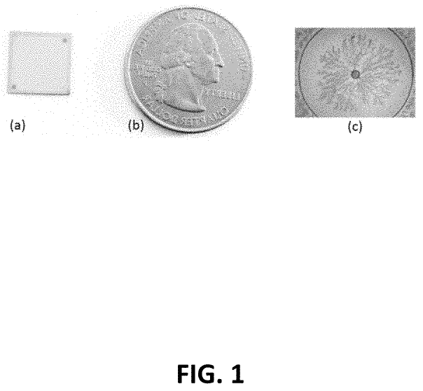

Dendritic tags are a transformative technology based on metallic patterns produced by an electrochemical process that offers uniqueness, unclonability, integrity, and low-cost properties. One such example is shown in FIG. 1. FIG. 1(a) illustrates a glass substrate wafer panel of about 1 cm square, which includes 24×24=576 dendrites. FIG. 1(c) shows one of those dendrites from FIG. 1(a): a pattern of radially arranged metal dendrites grown on ink jet printer paper. FIG. 1(b) shows a quarter coin for scale.

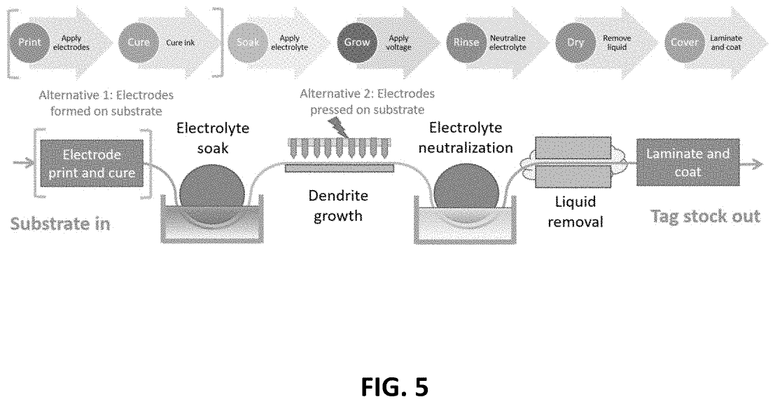

In the embodiment of FIG. 1(c), the dendrite skeletons are made of silver, which has been grown out of an electrolyte ion conductor on a cellulose substrate (i.e., paper) by electrolysis. This process is set forth in additional detail below in reference to FIG. 5. Other metal materials are usable for dendrites according to inventive embodiments, such as tin copper, zinc, gold, or iron. Referring still to FIG. 1(c), in that embodiment, silver is used because it results in a very stable pattern because it is generally nonreactive. Additionally, silver is bio-safe and causes minimal skin allergy, which makes its use advantageous for low cost consumer products, and even for food products. Indeed, even the accidental ingestion of the amount of silver used to produce quarter sized dendrites such as that shown in FIG. 1(c) would be medially safe.

While FIG. 1(c) shows a relatively large dendritic pattern, this is not a requirement. The overall size of a dendrite and its expected granularity may vary. Various application-oriented design parameters will generally dictate the branching morphology. Branch lengths can range from millimeters to sub-micron dimensions with thicknesses typically less than 100 nm.

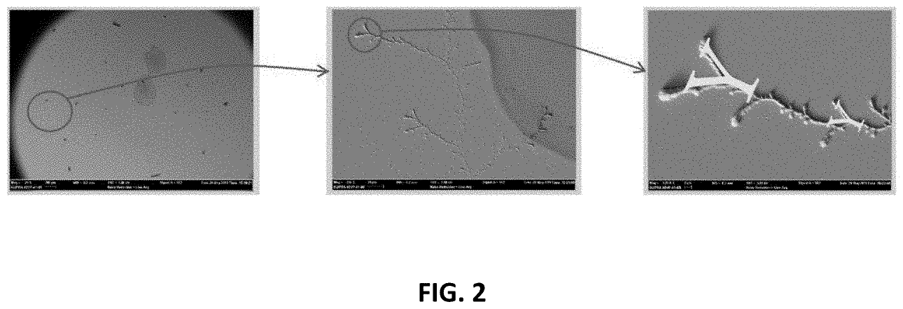

The pattern growth is based on the diffusion and drift of silver atoms in the electrolyte which are reduced on the growing feature (e.g., an electrode) to create the dendritic fractal pattern. Due to the electrochemical rules that govern the branching process, the dendritic patterns exhibit the property of self-similarity at different magnifications. That is to say, that zooming-in on the dendrite pattern continues to reveal a similar pattern of y-like shapes at different scales. This can be seen in FIG. 2, which shows a series of y-like shapes at different magnification scales. (The screen shots of FIG. 2 were taken from the ImageJ software.) The self-similarity of dendrites means that their fractal structures can be characterized by a Hausdorff-Besicovitch (or fractal) dimension, D, a number that is related to how the pattern fills the space in which it forms. This feature may be used by inventive embodiments to trim fake branches from the dendrite skeleton when extracting numerical information from the dendrites.

The infinity-approaching granularity of the formed patterns provides extremely high entropy for the numerical representation of patterns. Due to the fabrication process of electrochemically-grown silver dendrites, the average length of branches at each level is half of the preceding level, hence it is easy to grow dendrites with tens of layers. Considering m=10 originating branch and only L=20 levels, the number of bifurcation points becomes N=m×2^{L}=1.05×10⁷, and if each bifurcation point is represented by B=16 bits quantifying the length and orientation of the branch terminating to that point, then the number of extracted bits is BN=1.68×10⁸. This provides an entropy of 2^{BNH(b)}=2^{mBH(b)2}^{^{L}} which is 2^{1.6×10}^{⁸} for H(b)=0.01. In other words, it generates more than enough combinations to label every single molecule on earth (estimated to be about 13×10⁵⁰), assuming adequate ability to image and resolve branches at all 20 levels.

Here, H(b): (0≤H(b)≤1) is the entropy of each bit for rule-based branching process with inherent randomness. There is H(b)=1 for equiprobable Bernoulli distributed bits, and H(b)=0 for a fully deterministic branching process. It is noted that this entropy is without considering the randomness provided by the curvature of the branches, the diverse topology of graphs beyond binary tree, and more importantly the 3D features of the dendrite. That is to say, this level of entropy is present for a 2-D projection of a dendrite. Needless to say that this extremely high entropy guarantees the uniqueness of randomly generated patterns, but is not required for most applications. Indeed, the bottleneck is the imaging resolution and the supporting computational power to execute the utilized authentication algorithm, when scaling up to large-scale networks. The 3D pattern of these devices, inherited from the fabrication technology, prevents copying with existing technology (similar to holograms). Additionally, due to the hierarchical structure of the resulting dendritic patterns, the depth and resolution of scanning are adjustable to balance between the specificity and sensitivity of the utilized identification method.

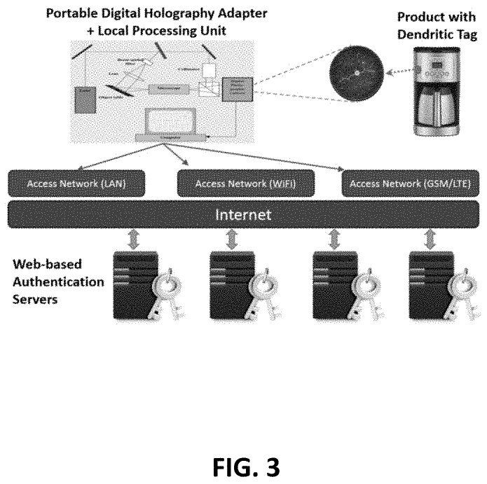

FIG. 3 illustrates a conceptual system for characterizing, enrolling and then authenticating dendritic tags according to an inventive embodiment. In the conceptual system of FIG. 3, an authentication authority fabricates dendritic labels (according to a process such as the ones described in reference to FIG. 5), or receives already fabricated labels. Using the system shown in FIG. 3, a dendritic tag is first imaged under magnification using a machine vision system. In the example of FIG. 3, a 3D imaging unit using digital holographic imaging is used. According to the example method, images of the dendrite structure are captured by a digital holographic imager using monochromatic illumination. The resulting digitized image data undergoes a number of exemplary pre-processing steps, which may include (a) image enhancement, (b) gray-scaling (c) binarization (d) particle filtering, and (e) thinning with details. Then, the extracted morphological information of each dendritic pattern is converted into a representative graph, which enables using the subsequent robust and low-complexity graph-based authentication. The image preprocessing and graph conversion can be executed by a local processing unit (cellphone, laptop or server computer, which may be local to the imaging system, or may be remotely located or accessible over a network such as the Internet or a local intranet). Additionally or alternatively, the image capture and processing steps set forth above may be executed on more than one processor distributed over a network in communication with a local processor or the camera system directly. For example, in the event that there is limited local processing power, especially for high-resolution imaging, edge or cloud computing can be used to push the bulk of the computation load to the servers located at the edge of the access network (e.g., eNB nodes in LTE systems) for accelerated performance.

Once the image data has been processed, the dendritic pattern is mathematically characterized, and a mathematical representation of the dendritic pattern is generated and stored, along with other information regarding the label and/or product, such as a product description, manufacture date, lot or batch identification, or data relating to the chain of commerce, such as shipping information or distributor identification. These data may be stored in a database located at, or in secure electronic communication with, an authentication authority, which may be original product manufacturer or the tag manufacturer, as described below. In certain embodiments, a copy of the representative tree for each dendrite tag is stored in a web-based datacenter during the registration phase and used for on-demand authentication.

In preferred embodiments, the image data is translated into a mathematical representation of the tree structure in a data efficient manner. In order to accomplish this, inventive embodiments employ a novel graph-theoretic method for structural image matching that takes advantage of the unique properties of dendritic patterns for an accelerated operation. This method utilizes graph matching as a surrogate algorithm for image matching and enables several key features. Firstly, it drastically reduces the storage and communication overhead by converting high-resolution images (in 10 MB˜1 GB range) into tree-based data structures (10 KB˜100 KB range) while preserving more than 99+ percentage of the device-specific morphological information. Secondly, it makes the identification/authentication mechanism robust to noise and imaging artifacts. This novel graph-matching algorithm utilizes new concepts of probabilistic linkage and local subnetwork inconsistency penalization for approximate graph matching. The specifics of the graph building procedure will be discussed more fully below.

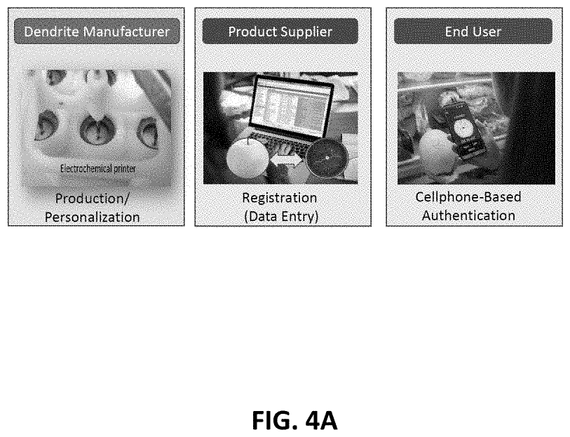

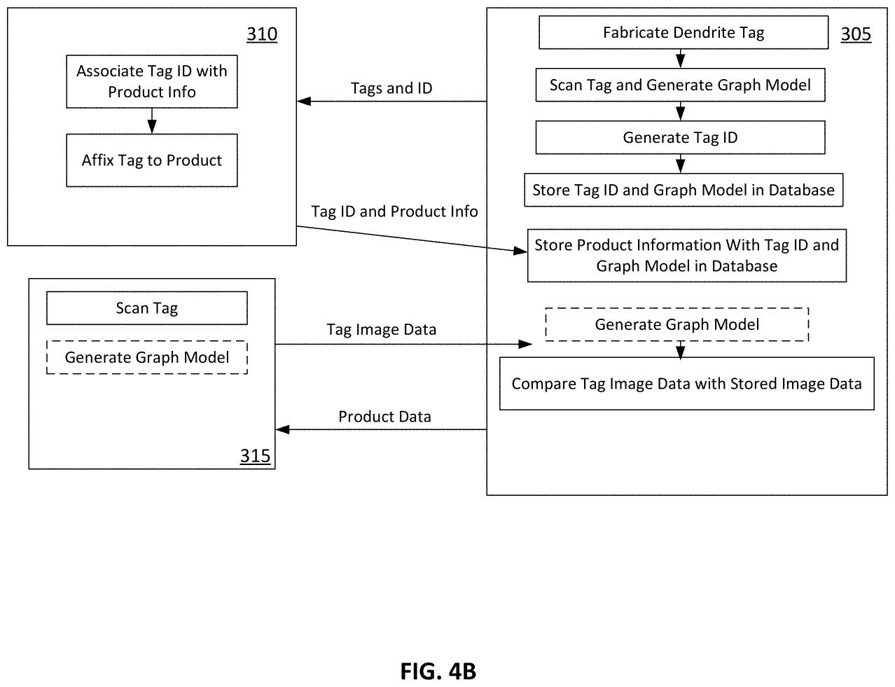

FIG. 4A schematically illustrates an exemplary process flow for a dendritic tag as it goes through its life cycle. As shown, first a tag manufacturer fabricates a dendritic tag using, for example, an electrochemical printing process or an electrolytic growth process. These processes will be described below in reference to FIG. 5. Then, the tag is imaged and characterized, and a mathematical representation of the dendritic pattern, i.e., graph information, is extracted. The dendrite tag manufacturer enters the extracted graph information (Gᵢ^{(R)}) and personalized unique identifiers (IDᵢ) for each dendritic tag into a web-accessible secure database, as a reference information. The unique identifiers may include a serial number of the individual tag, information about its fabrication (e.g., fabrication date, lot number, etc.).

Next, in a registration phase, the product supplier, for instance a food production company, associates tags with product descriptive information Dᵢ (e.g., product production date, expiration date, address information, ingredients, user instructions, an individual product serial number, identifying information regarding the manufacture, and identifying information regarding distributors and/or retailers to whom the product is to be sold or distributed). The product manufacturer may then registers the triplet (IDᵢ, Gᵢ^{(R)}, Dᵢ) in a web-accessible database as a ready-to-use product. The product manufacturer applies the label to the product and releases it into commerce. While the steps described above contemplate the original tag manufacturer acting as an authentication authority and acting as a custodian of the combined data associated with the tag, this is not a requirement. The product manufacturer may receive tag data from the tag manufacturer and then act as the custodian of the combined triplet data set, and perform authentication verifications itself.

It is contemplated that product manufacturers using dendritic tags according to inventive embodiments may register tags and product information in as part of a bulk or volume process using a web-based application. Applicants have developed a cellphone-based registration system usable for on-demand registration of lower volumes, but a personal computer based system is contemplated for higher product volumes. It should be realized that imaging of a tag by the product manufacturer is not necessary for registration, or even for authentication. It certain cases reels of unique tags can be provided with separate, but associated, tag identifiers (i.e., serial numbers or other alphanumeric designators) that can be used to associate the product manufacturer supplied information Dᵢ with the tag information held by the tag manufacturer.

After a tag has been registered by a product manufacturer, the product carrying the tag enters the stream of commerce and the tag may be authenticated by downstream recipients of the product, such as end users, but also distributors or retailers.

The end-user, in an authentication phase, can use a laptop computer or a mobile phone to authenticate the product and retrieve associated information. In one embodiment, a server-client authentication mechanism is used, where the local processor (in the possession of the party in possession of the tagged product) converts the dendritic pattern into a representative test graph Gᵢ^{(T)}. The Authentication request message (IDᵢ, Gᵢ^{(T)}) is sent by the local processor to the web-based authentication center, which may be a second processor having access to the secure enrollment database. The second processor may be in the possession of the authentication authority, whether that be the product manufacturer or the tag manufacturer. Upon receipt of the authentication request message, the authentication authority compares the test graph to the stored reference graph according to a graph matching algorithm. If the graph matching algorithm outputs an acceptable similarity score between the test graph Gᵢ^{(T)} and the reference graph Gᵢ^{(R)}, then the network access is granted and the product information Dᵢ is provided to the user. In some cases, rather than receiving the entire product information data Dᵢ the end-user may receive a subset of that information and/or an indication that the product is authentic or has matched the stored reference tag data.

An alternative exemplary arrangement and method of usage for dendritic product tags according to inventive embodiment is shown in FIG. 4B. In the arrangement of FIG. 4B, there are three entities: the tag manufacturer 405, which acts as an authentication authority and a store of product data, a product manufacturer 410, and an end user 415. It is contemplated that the functions of all of the entities shown in FIG. 4B may carry out their respective functions using a computing device equipped with a programmable processor in electronic communication with non-volatile storage having disposed thereon computer readable instructions that may cause the processor to execute certain method steps. It is also contemplated that the end user's computing device may be a camera-equipped mobile phone running a downloadable application. It is also contemplated that the entities shown in FIG. 4B may communicate among themselves over a computer network such as a secure intranet, a mobile network such as a 5G or 4G/LTE network, or the internet. It is also contemplated that the functions and method steps depicted in FIG. 4B may be performed by other entities or shared between entities. Some of these alternative arrangements are discussed below.

Still referring to FIG. 4B, a tag manufacturer 405 fabricates dendritic product tags according to methods such as those described below in reference to FIG. 5. In one embodiment, the dendrites are grown or deposited onto adhesive backed product tags, coated with a durable transparent substrate. This may done as part of a bulk process by which multiple dendrites are formed on a roll of adhesive backed substrate, which is subsequently coated with a transparent, protective encapsulant layer. Tag manufacturer 405 scans (i.e., optically images) the dendritic structure of the tag, and generates a graph model of the dendrite structure, according to the methods discussed below. This graph model is stored in a secure database at or securely accessible by the tag manufacturer. In certain embodiments, the database may be encrypted by any known encryption method.

The tag manufacturer may generate a tag ID, which is associated with the dendrite graph model in the database. For example, the two pieces of data may be stored together in the same data structure or object in the tag manufacturer's database. It is contemplated that the Tag ID may be read and/or decoded without access to the graph model. For example, the Tag ID may be a serial number, which is printed on the tag adjacent to the dendrite. In other embodiments, the Tag ID may be encoded in a bar code or 2-D QR code, which again, may be adjacent to the dendrite structure on the tag. In alternative embodiments, the dendrite structure itself, or data derived therefrom, acts as a tag ID, but in these embodiments, any party wishing to identify the tag must generally have the ability to image the dendrite. In embodiments where there is an easily readable tag ID, a product manufacturer need not image the tag.

Referring still to FIG. 4B, the tag manufacturer sends the manufactured product tags, along with the tag IDs, if generated, to a product manufacturer. The product manufacturer may associate additional data with the tag in a database. In the embodiment of FIG. 4B, the product manufacturer may undertake a tag registration process whereby it transmits to the tag manufacturer product information along with information identifying the tag to which the product information pertains. Exemplary product information may include the product name, manufacturer date, expiration date, product description, information identifying the product manufacturer, information regarding the expected chain of commerce (e.g., approved distributors for the product), instructions for using the product, or other information pertaining to the product which may be useful for the product's end user to have (e.g., a web address including product information, instructions, software or firmware updates, etc.).

In one embodiment, the product manufacturer may register the tag through a web-based portal provided by the tag manufacturer, a downloadable software program or a mobile application. In the embodiment of FIG. 4B, the registration process involves the product manufacturer sending to the tag manufacturer the product information and the tag ID, or entering the product information through a web-based portal which associates the information with the tag ID. In embodiments where there is not a separate tag ID, the product manufacturer may optically scan the tag, generate tag identifying graphical information (e.g., a graph model) of the tag, and then send that information along with the product information to the tag manufacturer. The tag manufacturer then associates the product information with the tag information already stored in its database, e.g., by storing the product information in the same data structure or object in the database as the dendrite graph model for the tag and the tag ID, if generated.

The product manufacturer will affix the tag to products, which then enter the stream of commerce where they are encountered by various end users 415. A prototypical end user is an end purchaser of a retail product, but other end users may include distributors and product retailers. In the embodiment of FIG. 4B, and end user encounters a product (e.g., having purchased it, or seeing it in a retail outlet). The end user can take an image of the dendritic tag, e.g., preferably with a mobile phone camera with auxiliary magnification optics. A mobile application running on the user's phone, provided by the tag manufacturer, product manufacturer or other authentication authority, generates a graph model of the tag from image data. This graph model is then transmitted to the authentication authority. In alternative embodiments, an image of the dendrite itself, rather than the graph model of the tag, is transmitted, and the recipient (e.g., the tag manufacturer) derives the model of the end user's tag itself.

The authentication authority, in this case the tag manufacturer 405, receives the tag image data from the end user 415. Again the tag image data may be an image of the tag, or a locally constructed graph model derived from locally taken image data. In the event that the end user sends image data, the tag manufacturer generates a graph model of the tag in possession of the end user (sometimes referred to herein as a “test tag” or a “test image” in contradistinction to the reference data previously taken of the dendrite by the tag manufacturer). The graph models, that is the mathematical representations of the tag, are compared. If the tag manufacturer finds that the tag in the possession of the end user matches the reference graph model, product information is returned. The product information may include an indication that the product is authentic, as well as all or some of the other product information supplied by the product manufacturer and stored at the tag manufacturer in association with the tag ID. In a preferred embodiment, the end user (again, preferably the end user's application) sends the tag ID as well as the tag image data. The tag ID may be used by the tag manufacturer to locate the correct reference information in its database, which increases the efficiency of the comparison step.

It is contemplated in the discussion above that the tag manufacturer acts as the authentication authority and stores the product information, the graph model, and the tag ID, but this is not a requirement. In an alternative embodiment, the tag manufacturer may provide the product manufacturer with the graph model of the tag, as well as application software capable of comparing the reference graph model with locally generated test models, and the authentication steps illustrated may be performed by the product manufacturer.

It is further contemplated that the steps of transmission of the graph model from the end user to the authentication authority should occur securely. Accordingly, communications from the end user to the authentication authority may be encrypted. If public-key, private-key cryptography is used, the authentication authority or product manufacture may include public keys (or the means for generating such) with the application being used by the end user, with the corresponding private key being held by the authentication authority.

In preferred embodiments, tag image data, both at the initial characterization stage and the authentication stage, is translated into a mathematical representation of the tree structure in a data efficient manner. This representation is called a “graph model” in FIG. 4B. In order to accomplish this, inventive embodiments employ a novel graph-theoretic method for structural image matching that takes advantage of the unique properties of dendritic patterns for an accelerated operation. This method utilizes graph matching as a surrogate algorithm for image matching and enables several key features. Firstly, it drastically reduces the storage and communication overhead by converting high-resolution images (in 10 MB˜1 GB range) into tree-based data structures (10 KB˜100 KB range) while preserving more than 99+ percentage of the device-specific morphological information. Secondly, it makes the identification/authentication mechanism robust to noise and imaging artifacts. This novel graph-matching algorithm utilizes new concepts of probabilistic linkage and local subnetwork inconsistency penalization for approximate graph matching. The specifics of the graph building procedure will be discussed more fully below.

### Dendrite Fabrication Process

An exemplary fabrication process for dendritic tags according to inventive embodiments will now be described in reference to FIG. 5. The process of FIG. 5 begins by applying a coating to the substrate (if necessary) that will hold the electrolytic growth medium. Next, the coated substrate may receive electrodes, which preferably are printed directly on the substrate or pushed onto the substrate and into contact with the electrolyte as separate elements. In the event that the electrodes are assembled to the substrate as separate elements, this step may occur after the electrolyte is applied. A liquid or gel electrolyte is then applied to the substrate, and a voltage is applied across the electrodes, causing growth of the metal dendrite. The electrolyte is then neutralized using a fixer and the material is rinsed and dried so that it can be coated with a protective layer.

### Graph-Theoretic Authentication Approach

Inventive embodiments achieve the advantages described herein because they leverage a novel method of mathematically measuring and characterizing (i.e., representing) a metal dendritic structure in a way that is computationally efficient and not storage intensive. Fundamentally, there are two processing steps involved: graph representation, by which a graphical model of the tag is initially generated, and graph matching, by which image data of the dendrite is process and compared to the initial model.

The goal of graph representation is to encode the morphological properties of dendritic patterns into graph-embedded numerical information as a new approach to extracting image descriptors suitable for dendrites.

Some generic image descriptors with proven superior performance include Scale-Invariant Feature Transform (SIFT), Speeded Up Robust Features (SURF), Features from Accelerated Segment Test (FAST), Harris, Histogram-Oriented Gradient (HOG), Binary Robust Independent Elementary Features (BRIEF), Oriented FAST and Roasted BRIEF (ORB), Binary Robust Invariant Scalable Keypoints (BRISK), and the modified version of Harris-Min Eigen just to name a few. These methods are generally directed to extracting a refined set of key points to mimic the main properties of images using ideas like the distance of Gaussian (DoG), differential geometry, 2D gradient, Hessian matrix approximation, and wavelet response.

These image descriptors have good performance. However, because these are generic image data characterization methods, they are necessarily suboptimal when applied to specific image types, for which, a custom methodology would have better performance. This fact motivated researchers to implement application-specific image descriptors for face recognition, fingerprint identification, and cross-spectral biometric imaging. For instance, facial features include hand-crafted visual, statistical, transform coefficient, component-based, and algebraic features. Also, learning-based feature dictionaries have shown a reasonable performance. An alternative method (to explicit feature extraction) is projecting facial images into lower space using dimensionality reduction methods (e.g., Eigen Face, Component Analysis (PCA), and Linear Discriminant Analysis (LDA)).

Such an elegant, application-specific image feature extraction method did not hitherto exist for the newly invented dendritic tags. This disclosure provides a novel feature extraction method for dendrites that utilizes the special topology of dendritic patterns, namely the self-similarity, and the hierarchical radial bifurcations, to extract keypoints that preserve maximal geometry of the dendrite skeleton with as few points as possible.

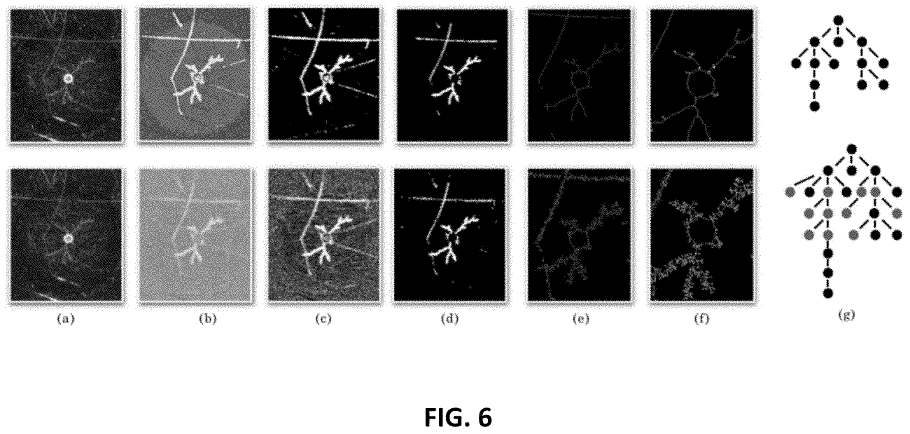

The present approach describes a representative tree-shaped weighted directed acyclic graph (WDAG) for each dendritic pattern which involves a pipeline of preprocessing steps including (a) image import, (b) conversion to YCbCr space, (c) segmentation, (d) binarization, (e) smoothing, (e) skeletonizing and thinning, (f) bifurcation detection, and (g) the graph representation. These steps are illustrated in FIG. 6 as applied to an exemplary metallic dendrite printed on silica substrate (top figure of FIGS. 6a-g). The bottom figure for FIGS. 6a-g is a version of the same dendrite to which noise has been added for the purposes of testing the method's ability to extract and model the dendrite. Thus, FIG. 6 illustrates: (a) the original image, (b) the image in YCbCr space, (c) the image after segmentation, (d) the binarized image, where the image data is translated to monochrome by thresholding the pixel values using the median of the pixel intensity histogram, (e) the smoothed image, (e) the extracted and thinned skeleton, (f) the extracted graph vertices (feature points), and (g) the representative graph.

Referring still to FIG. 6, an image is generated of a dendritic tag, and a 3×3 pixel sliding window with 1 pixel stride is used to extract the main skeleton of the dendritic pattern (FIG. 6a). Features in the resulting image are identified, which features include the seed point (the origin of the growth pattern of the dendrite, prior to any branches), the points of bifurcation and branch termination points. These features are extracted from the seed point, and out toward the child levels. The skeletons are thinned (into one-pixel width) and trimmed (by excluding fake branches) by a combination of hard-thresholding and particle filtering. As an example of this, the dendritic structure will be continuous, composed of linear segments between bifurcation points, and will have no crossing branches. Applying these or similar rules allows particles and unconnected or crossing features (e.g., scratches) to be removed. An object recognition algorithm is executed to extract the dendritic tag from the background image. In the developed tree structure, each node is associated with a two-element vector representing the length and orientation of the branch terminating to that node (i.e., the angle with respect to an arbitrary, but consistent, reference axis, of a line connecting the node to its parent node).

Thus, as a result of the methodology discussed above, the dendritic pattern is represented by a collection of nodes, each node representing one of a seed, bifurcation or branch termination point, where each node is associated with data regarding the length and orientation of a linear representation of the branch connecting that node to its parent node. The nodes may also be organized by level, that is, the number of branchings between the node and the seed point. This graph representation (shown schematically in FIG. 6(g)) retains more than sufficient entropy for a reliable authentication leaving zero probability for misidentification of similar patterns.

One aspect of this approach includes developing graph-embedded error correction codes for refining the extracted trees. Currently, hard thresholding and particle filtering are used to eliminate fake branches arise from noise, scratches, and imperfect imaging. The dendrite growth process obeys electrochemical rules and shows properties like self-similarity. For instance, applicant's investigation of a large dataset of dendrites confirms that two randomly generated branches never cross one another due to the repulsion force among negatively-charged liquid electrolyte solutions. This has enabled the development of a data-driven model to capture the mathematical rules governing the branch growth process and its use for developing error correction codes to filter out fake branches. This process will now be described.

The error checking algorithm uses a belief propagation algorithm for decoding the information, while self-similarity is used to refine the beliefs. In this approach, each bifurcation point nᵢ is assigned a prior probability of being an actual bifurcation point pᵢ. To refine these probability assignments, a belief propagation through Graph Neural Networks (GNN) is used. GNNs are a variant of Convolutional Neural Networks (CNN), which enable network-based inferences and classification for arbitrary graphs beyond the local receptors used for image processing by CNNs. The main research question is defining the propagation rules that take into account the discussed self-similarity probability. For instance, the bifurcation point nᵢ at a specific level lⱼ if forms “Y” shape with a scales sᵢ between those of the lower layer lⱼ₋₁ and higher layer lj+1 (i.e. Σ_{m∈l}_{_{j−1}}s(m)≤s(nᵢ)≤Σ_{n∈l}_{ⱼ₊₁}s(n)) are more likely to be actual bifurcation points.

### Graph Matching.

Graph matching is a powerful technique for assessment of similarity of various structures. Graph matching is commonly employed in object recognition, protein classification, face recognition, and fingerprint identification. In most applications, the matching problem boils down to finding graphs with similar structures using methods like exact and inexact matching, join matching of multiple graphs, and higher-order matching.

Additional details relating to the graph matching method employed here is specified in the publication Chi et al. “Consistency penalized graph matching for image-based identification of dendritic patterns.” June 2020; IEEE Access PP(99):1-1, which is herein incorporated in entirety by reference.

The exact graph matching with zero-distortion node mapping, the so-called graph isomorphism is known to be in NP (neither P nor NP-complete). However, there exist special structures that can be solved in linear time. The majority of heuristic algorithms proposed for this problem are computationally intensive. Another major challenge in using graph matching methods for image recognition is the sensitivity of the extracted features to noise and imaging artifacts. For instance, most graph matching algorithms such as greedy algorithms and labeling methods that employ full graph structures for comparison purposes demonstrate exponential complexity with the number of nodes for the worst-case scenario. Graph matching problems can be cast as nonlinear optimization problems. Using some sort of relaxation in labeling can significantly reduce the computational complexity compared to the exact labeling methods. Another technique to reduce the computational complexity is subgraph matching which is based on reducing the full graph matching to multiple smaller subgraph matching sub-problems. The current methods of structural comparison between unweighted graphs are not suitable for our application, when a big majority of information is embedded in the node weights, and not in the structural variability. Secondly, these methods are general, and do not benefit from the simplifying consideration of the planar tree-like patterns of dendrites.

One graph matching algorithm enables a low-complexity top-down comparison mechanism that makes a pairwise mapping between the nodes of the test and reference trees at each level, while scanning the tree from the root node (level L=1) toward the leaves at the outer ring. After level synchronization, the nodes of the test and reference graphs at each level L, namely G_{L}^{(T)} and G_{L}^{(R)} are compared and the linkage L_{L}={(v,w)|v∈G_{L}^{(T)}^{_{(T,R)}}, v∈G_{L}^{(R)}} is established based on their local morphological similarity. Then, the process proceeds to the next level L+1 and the same process repeats on the emerging subnetworks of the matched nodes. This inductive process continues until the leaves of the tree, or the outermost level, is reached. Once the mapping is completed, an overall similarity score is computed based on the level-based similarity scores. Similarity between the inner levels (closer to the seed) is weighted more heavily than similarity in the outer levels.

This algorithm has been shown to beat other feature selection methods in capturing the most informative descriptors and providing accurate matching in the presence of heavy noise, rotation, scaling, and skew (up to about 10°). The robustness of this algorithm is inherited from the proposed graph representation method that naturally eliminates the imaging artifacts. In particular, the accuracy of the proposed algorithms tops that of the state of the art image authentication methods that use distance metrics, classification methods like expectation maximization, k-nearest neighbor, support vector machines (SVM), Bayesian methods, and graph matching techniques. This enhanced improvement is achieved with much less image descriptors (by a factor of 10 to 100) compared to the benchmark feature selection methods.

A key problem that can compromise the accuracy of this top-down algorithm is the loss of level synchronization between the trees due to the emergence of fake nodes in the test object (insertion errors) due to noise, imaging artifacts, and scratches on the dendrite surface, especially after heavy use. Such an impact is shown in FIG. 6, where the test object includes a large number of misidentified nodes, even after pre-processing. Also, some branches may be lost due to physical damage to the test dendrite (erasure errors). To mitigate this issue, a novel level re-synchronization mechanism is included, which addresses unit-level shifting.

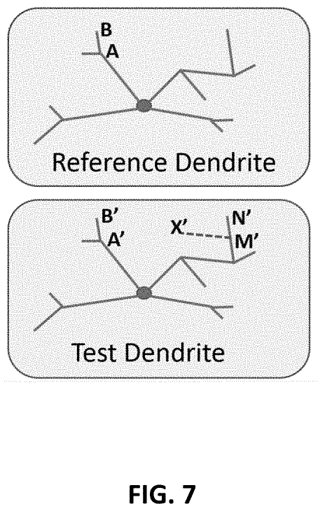

To completely mitigate the issue of level synchronization loss and boost the performance of the previous algorithm, this disclosure comprises a probabilistic graph matching algorithm that uses a structure-free traversal method. This work is inspired by the fact that level synchronization is an intrinsic problem of any top-down or bottom-up matching algorithm. Therefore, this disclosure proposes to radically shift from the structured traversal methods to a structure-free and ad-hoc matching approach to fully alleviate the synchronization loss. The idea is to make probabilistic linkages between the nodes of the test and reference graphs based on their pairwise distances using the modified version of Munkres' Assignment. However, imaging artifacts may alter the node values and cause false mapping (e.g., the mapping between nodes E and B′ in FIG. 7). The consistency of the paired nodes is investigated by evaluating their local sub-networks (i.e., parents, siblings, and children). The nodes that exhibit higher consistency scores are more likely to be corresponding to correct matches, while the ones with low consistency scores may represent false matches.

More specifically, all paired nodes v,w within L_{L}={(v,w)|v∈G_{L}^{(T)}^{_{(T,R)}}, v∈G_{L}^{(R)}} were examined to compute consistency scores

$${S}_{C} ( v , w ) = {α}_{C} I [ P ( v ) ↔ P ( w ) ] + {β}_{C} \frac{{\sum }_{m ϵ C ( v ) , n ϵ C ( w )} I [ m ↔ n ]}{max ( \vert C ( v ) \vert , \vert C ( w ) \vert )} + {γ}_{C} \frac{{\sum }_{m ϵ S ( v ) , n ϵ S ( w )} I [ m ↔ n ]}{max ( \vert S ( v ) \vert , \vert S ( w ) \vert )}$$

where I( ) is the indicator function, and m↔n represents the linkage between nodes m and n. The notations P(v), C(v), and S(v) denote the parent, the set of children, and the set of siblings of node v, respectively. The tuning parameters α_{c}, β_{c}, γ_{c} are set with cross-validation. The consistency scores are indicators of the validity of the established links and hence are used to assign link break probabilities. Then, a probabilistic screening is performed by which the established links are broken based on their obtained break probabilities.

A visualization of this concept is shown in FIG. 7. First, the reference and test dendrite nodes data are normalized so that they can be directly compared without regard to the magnification or scale at which the respective test and reference models were constructed. Normalization is done on both the length and orientation parameter of all nodes based on the mean and standard deviation of these parameters within each graph. Next, candidate node pairs between the graphs are matched, which can occur by a random selection process initially. The initial match may be done by selecting a first node in the test graph, then finding a node in the reference graph with the same or similar branch length and orientation. Referring still to FIG. 7, branches AB and A′B′ are the actual matching branches between the reference and test dendrites. However, a fake branch M′X′ caused by a scratch has apparently decreased the length of a branch terminating at N′. Therefore, the Ad-hoc matching mistakenly maps branches AB to M′ due to a close alignment between their length and orientation. The algorithm checks this match by evaluating the consistency of local subnetworks associated with the matched nodes. In FIG. 7, the false node (at M′) and the true node at A will exhibit a low consistency score, and this linkage is broken. AB will eventually by mapped to the correct branch A′B′.

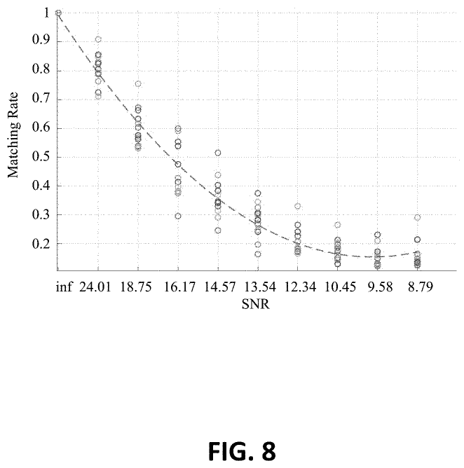

The nodes with broken links are added to the pool of unmatched nodes to be included in the next re-matching phase. This continues until the algorithm converges to a stable matching (in about 10 iterations). The ultimate result of this consistency-penalized probabilistic graph matching is a similarity score that is compared against an application-specific threshold to authenticate the tag. FIG. 8 demonstrates the performance of the developed algorithm in correctly matching the image descriptors when the test image is subjected to noise and skew.

The accuracy of the proposed algorithm (in terms of yielding the highest similarity scores between the test and corresponding reference object compared to other reference objects) remain above 98% for SNR>10 dB that shows a great margin with respect to the state-of-the-art methods. This stunning gain is due to the fact that this method (in contrast to other generic methods) is custom-built for dendritic patterns. This research thrust poses new research paradigms in graph theory to the scientific community. In particular, an optimization framework is required to address the trade-off between the sensitivity and specificity of the algorithm by adjusting the granularity of the extracted images. Developing optimal measurement and compression policies to further reduce the inspection latency by regulating the processing and communication overheads is another research question to be pursued.

### Dendrite Portable Reader and App Design

Two different inspection modes, 2D and 3D, have been designed. In the 2D imaging mode, regular cameras are used to capture 2D images, and the proposed graph-theoretic method is used for authenticating the dendrite tags using the method discussed previously. This solution is low-cost and appropriate for low-risk commercial applications.

However, stronger protection is provided by the digital holography method, which relies on digital holographic recordings of the dendrite images. This method uses a USB connection that can communicate with the cellphone or laptops for on-demand imaging. The front-end of the system is a local processing unit (LPU), namely a desktop computer, a laptop or cellphone equipped with a regular camera and/or a portable DH adapter. The information exchange is through an optional access network (e.g., Wi-Fi, Cellular System, LAN, etc.) to connect to the Internet that hosts the web-based authentication servers.

This low-cost implementation is designed to promote the widespread adoption of this technology. Today's laptop and smartphone cameras and processors are more than powerful to realize the disclosed reader solution, which involves high-resolution imaging, and a driver for object recognition and graph representation. This prototype includes a web-based authentication software along with a cellphone App for 2D imaging only.

The developed App includes a user-friendly Graphic User Interface (GUI) and requires little or no training. Implementing a portable 3D imaging equipment with local image processing capabilities using available platforms and operating systems (e.g., Windows, Linux, macOS) is the focus.

Regardless of the imaging mode (2D or 3D), the LPU scans the dendritic tag and analyzes the quality of the captured image. If it does not satisfy minimum quality requirements, the user is instructed to repeat the scanning. Once a successful scanning is confirmed, the LPU encodes the image into graph-embedded numerical information and initiates the authentication process. The computation-intensive graph-theoretic authentication (and the DH analysis in the 3D mode) is executed by the back-end software on a web-based server. In addition to enabling on-demand authentication of dendrites, the LPU can be used by the product manufacturers for registering newly produced tags and associating/editing product information (personalization). It is recommended to use the web-based software for volume registration, and the Laptop App for low-volume on-demand registrations. Parallel computing may be to accelerate the authentication speed, especially for volume authentication.

The described features, advantages, and characteristics may be combined in any suitable manner in one or more embodiments. One skilled in the relevant art will recognize that the circuit may be practiced without one or more of the specific features or advantages of a particular embodiment. In other instances, additional features and advantages may be recognized in certain embodiments that may not be present in all embodiments.

Reference throughout this specification to “one embodiment,” “an embodiment,” or similar language means that a particular feature, structure, or characteristic described in connection with the embodiment is included in at least one embodiment. Thus, appearances of the phrase “in one embodiment,” “in an embodiment,” and similar language throughout this specification may, but do not necessarily, all refer to the same embodiment.

What is claimed is:

1. A method of modeling a metal dendrite, comprising:
forming an image of the dendrite;
digitizing the image;
processing the digitized image resulting in processed digital image data;
analyzing the processed digital image data to identify features of the dendrite, and on the basis of the analysis, generating a numerical representation of the dendrite in the form of a graph.

2. The method of claim 1, wherein analyzing the digital image to identify features of the dendrite comprises identifying the dendrite's seed point, points of bifurcation and points of branch termination.

3. The method of claim 2, wherein generating a numerical representation of the dendrite in the form of a graph comprises: representing at least a portion of the dendrite as a series of nodes, each node representing one of the identified seed point, a point of bifurcation or a point of branch termination.

4. The method of claim 3, wherein each node is associated with a two-element vector representing the length and orientation of a branch terminating to the node.

5. The method of claim 4, wherein the each node is associated with a branching level of the dendrite.

6. The method of claim 1, wherein processing the digitized image resulting in a processed digital image comprises performing one or more of the following image processing functions: conversion to YCbCr color space, segmentation, binarization, smoothing and thinning.

7. A method of assessing similarity between a first numerical representation of a dendrite shape and a second numerical representation of a dendrite shape, each numerical representation comprising a series of nodes associated with a two-element vector representing a length and orientation of a branch terminating to the node, the method comprising:
selecting a first node in the first numerical representation;
selecting a first node in the second numerical representation;
determining that the selected first node in the first numerical representation matches the selected a first node in the second numerical representation on the basis of a comparison of the two-element vectors of each node.

8. The method of claim 7, further comprising normalizing the values of the two element vectors associated with nodes of the first numerical representation and the second numerical representation.

9. The method of claim 8, wherein the normalizing step is based on the mean and standard deviation of the values of the two element vectors of the nodes associated with each respective numerical representation.

10. The method of claim 7, further comprising computing a consistency score associated with a match between the first node in the first numerical representation and the first node in the second numerical representation based on a comparison of the two-element vectors of child, sibling or parent nodes for each of the first node of the first numerical representation and the first node of the second numerical representation.

11. The method of claim 10, further comprising comparing the consistency score to a predetermined consistency threshold, and if the consistency score exceeds the predetermined consistency threshold, selecting a second node in the first numerical representation and a second node in the second numerical representation for comparison.

12. The method of claim 10, further comprising comparing the consistency score to a predetermined consistency threshold, and if the consistency score does not exceed the predetermined consistency threshold, selecting the first node in the first numerical representation and a second node in the second numerical representation for comparison.

13. The method of claim 10, further comprising applying a weight associated with the pairing on the basis of the dendrite branching level associated with the nodes.

14. A method of authenticating an article of commerce, comprising:
fabricating a tag including a metal dendrite;
generating a digital image of the dendrite;
generating a first mathematical model of at least a portion of the shape of the dendrite as a collection of nodes representing one of the dendrite's seed, bifurcation or termination points, where each node is associated with a two-element vector representing a length and orientation of a branch terminating to the node;
storing the first mathematical model of at least a portion of shape of the dendrite in a database;
receiving a second mathematical model of at least a portion of the shape of a dendrite, wherein the second mathematical model represents at least a portion of the shape of the dendrite as a collection of nodes representing one of the dendrite's seed, bifurcation or termination points, where each node is associated with a two-element vector representing a length and orientation of a branch terminating to the node;
comparing the first and second mathematical models, and on the basis of the comparison, determining whether the second mathematical model was derived from the same dendrite as the first mathematical model.

15. The method of claim 14, wherein comparing the first and second mathematical models comprises normalizing the values of the two element vectors associated with nodes of the first mathematical model and the second mathematical model.

16. The method of claim 15, wherein the normalizing step is based on the mean and standard deviation of the values of the two element vectors of the nodes associated with each respective mathematical model.

17. The method of claim 15, wherein comparing the first and second mathematical models comprises:
selecting a first node in the first mathematical model;
selecting a first node in the second mathematical model, and
determining that the selected first node in the first model matches the selected a first node in the second mathematical model on the basis of a comparison of the two-element vectors of each node.

18. The method of claim 17, further comprising computing a consistency score associated with a match between the first node in the first mathematical model and the first node in the second mathematical model based on a comparison of the two-element vectors of child, sibling or parent nodes for each of the first node of the first numerical representation and the first node of the second numerical representation.

19. The method of claim 18, further comprising comparing the consistency score to a predetermined consistency threshold, and if the consistency score exceeds the predetermined consistency threshold, selecting a second node in the first mathematical model and a second node in the second mathematical model for comparison.

20. The method of claim 18, further comprising comparing the consistency score to a predetermined consistency threshold, and if the consistency score does not exceed the predetermined consistency threshold, selecting the first node in the first mathematical model and a second node in the second mathematical model for comparison.
